(19) United States
(12) Patent Application Publication
(10) Pub. No.: US 2017/0039539 A1
(43) Pub. Date: Feb. 9, 2017

(54) POINT-OF-SALE SYSTEM WITH A DETACHABLE BASE ACCOMMODATING A PRINTER

(71) Applicant: DUALITY FOCUS COMPANY LIMITED, Belize City (BZ)

(72) Inventors: KHAIRIL SINGGIH, City of Industry, CA (US); See-Hing TIANG, City of Industry, CA (US)

(21) Appl. No.: 14/859,109

(22) Filed: Sep. 18, 2015

(30) Foreign Application Priority Data
Aug. 6, 2015 (TW) 104212718

(51) Int. Cl. G06Q 20/20

(52) U.S. Cl. CPC G06Q 20/209

(57) ABSTRACT

A point-of-sale (POS) system with a detachable base accommodating a printer includes a lower case and an upper case. The lower case has a left edge portion and a right edge portion on which two resilient latching assemblies are respectively mounted. Each resilient latching assembly has a seat and a resilient element that is detachably mounted through the seat and is extendable and retractable. The upper case has a left sidewall and a right sidewall through which two openings are respectively formed. The resilient elements are respectively and detachably mounted through the two openings of the upper case for the upper case and the lower case to be assembled together. As the resilient elements of the resilient latching assemblies can be detachably mounted through the openings of the upper case, the upper case and the lower case for accommodating a printer therein can be easily and efficiently assembled.

The current application claims a foreign priority to application number 104212718 filed on Aug. 6, 2015 in Taiwan.

### BACKGROUND OF THE INVENTION

1. Field of the Invention

The present invention relates to a point-of-sale (POS) system and, more particularly, to a POS system with a detachable base accommodating a printer in the base.

2. Description of the Related Art

The aim of technological progress is to create a humanized environment and bring forth convenience to daily life and work in the living environment. To retail business owners, limited functions, such as printing receipts, calculating daily sales amounts and the like, provided by conventional POS systems are the daily issues that the business owners have to deal with. Hence, multi-functional POS systems have been brought into play and integrated with personal computers and printers to conveniently print out detailed transaction information besides just printing receipts of transactions.

With reference to FIG. 8, a conventional POS system includes a base 90, a support arm 91, and a screen 92. The base 90 has a printer mounted therein. A bottom end of the support arm 91 is mounted on the base 90. The screen 90 is pivotally mounted on a top end of the support arm 91. The base 90 further has an upper case 901 and a lower case 902 joined together with screws 93 to accommodate a printer in the base 90. However, upon maintenance of the printer, all the screws 93 must be removed in order to open the upper case 901 of the base 90 prior to removal of the printer. Such maintenance is time-consuming, effort-taking and inconvenient. Also, the upper case 901 and the lower case 902 fail to be properly assembled again when any of the screws are missing.

### SUMMARY OF THE INVENTION

In view of the foregoing time-consuming and effort-taking concerns upon maintenance of the printer of a conventional POS system, an objective of the present invention is to provide a point-of-sale (POS) system with a detachable base accommodating a printer.

To achieve the foregoing objective, the POS system with a detachable base accommodating a printer includes a lower case, two resilient latching assemblies and an upper case.

The lower case has a left edge portion and a right edge portion.

The two resilient latching assemblies are respectively mounted on the left edge portion and the right edge portion of the lower case. Each resilient latching assembly has a seat and a detachable lock.

The detachable lock is detachably mounted through the seat.

The upper case has a left sidewall and a right sidewall. Two openings are respectively formed through the left sidewall and right sidewall of the upper case to correspond to the two resilient latching assemblies, the upper case is joined to the lower case, and the upper case and the lower case are adapted to enclose a printer therein.

According to the foregoing structure of the POS system, when maintenance of a printer of the POS system is necessary and the upper case is detached, the resilient elements of the two resilient latching assemblies are pressed at the same time and the extendable and retractable nature of the resilient elements allows the resilient elements to be detached from the POS system through the openings of the upper case, such that the upper case can be easily removed. On the other hand, when the upper case needs to be put back, the upper case can be assembled with the lower case by respectively mounting the resilient elements through the openings of the upper case. Accordingly, the use of the resilient latching assemblies renders convenience and efficiency in assembly and disassembly of the upper case and the lower case.

Other objectives, advantages and novel features of the invention will become more apparent from the following detailed description when taken in conjunction with the accompanying drawings.

### BRIEF DESCRIPTION OF THE DRAWINGS

FIG. 1 is a partially exploded perspective view of a POS system with a detachable base accommodating a printer in accordance with the present invention;

FIG. 2 is a perspective view of the POS system in FIG. 1;

FIG. 3 is an exploded perspective view of a resilient latching assembly of the POS system in FIG. 1;

FIG. 4 is a partially enlarged perspective view of an upper case of the POS system in FIG. 1;

FIG. 5 is a partially enlarged perspective view of a lower case of the POS system in FIG. 1;

FIG. 6 is an enlarged operational side view in partial section of the POS system in FIG. 1;

FIG. 7 is another enlarged operational side view in partial section of the POS system in FIG. 1; and

FIG. 8 is a conventional POS system.

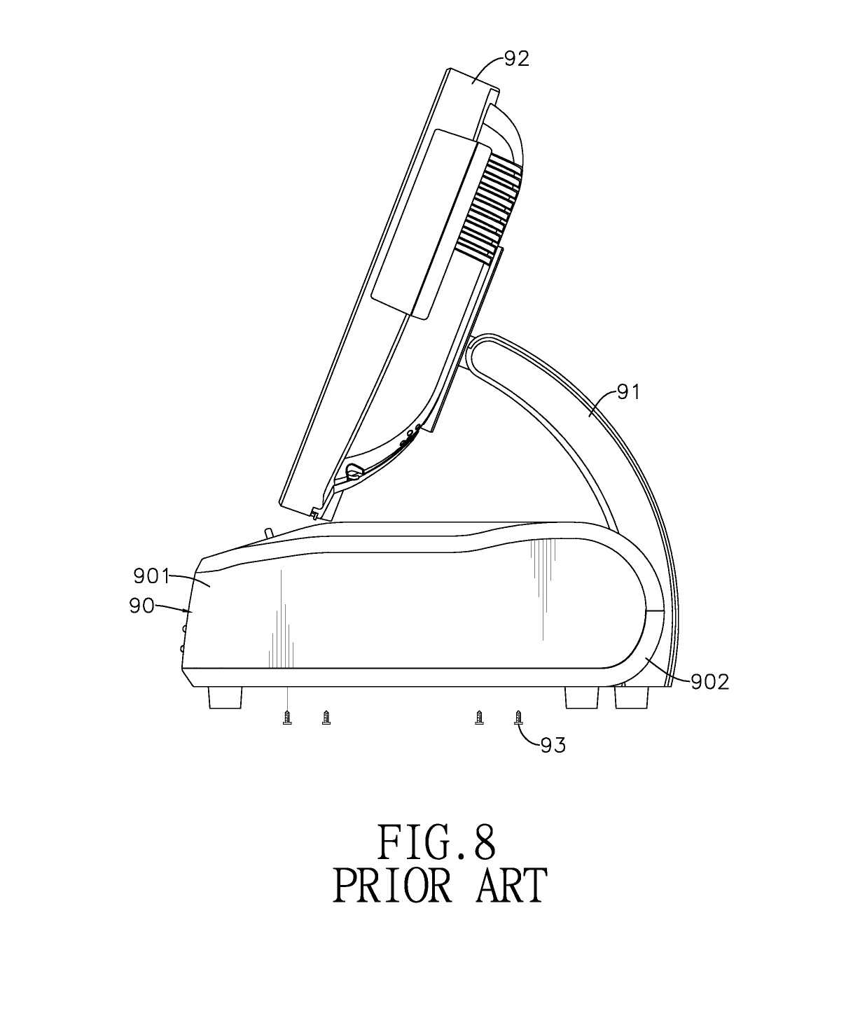

### DETAILED DESCRIPTION OF THE INVENTION

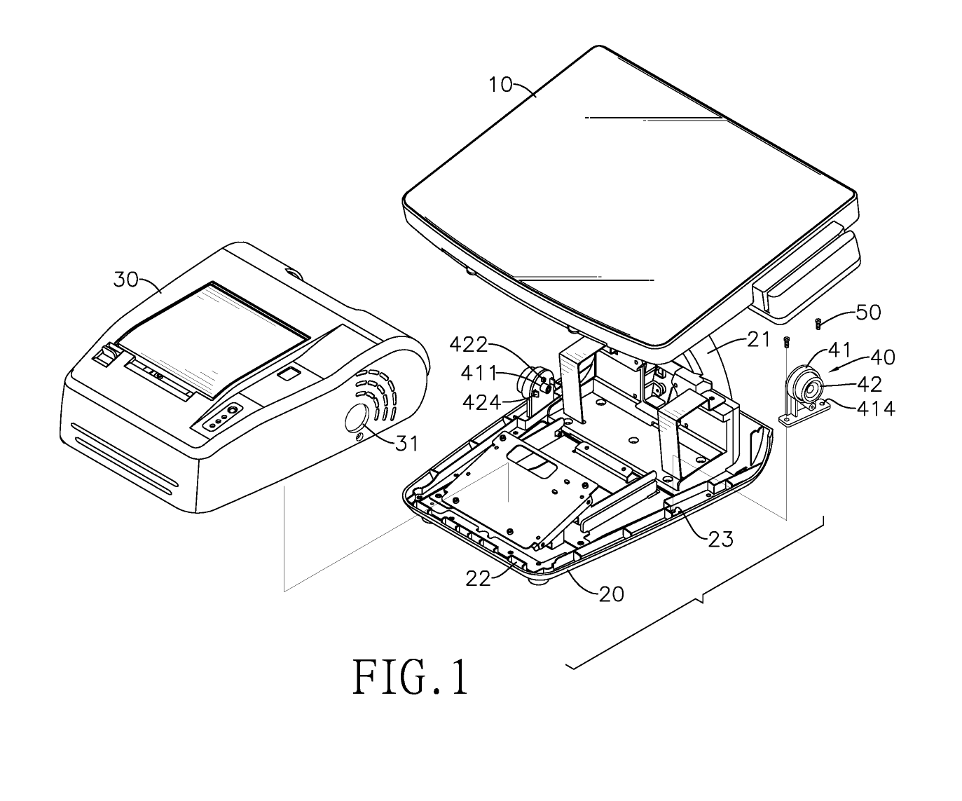

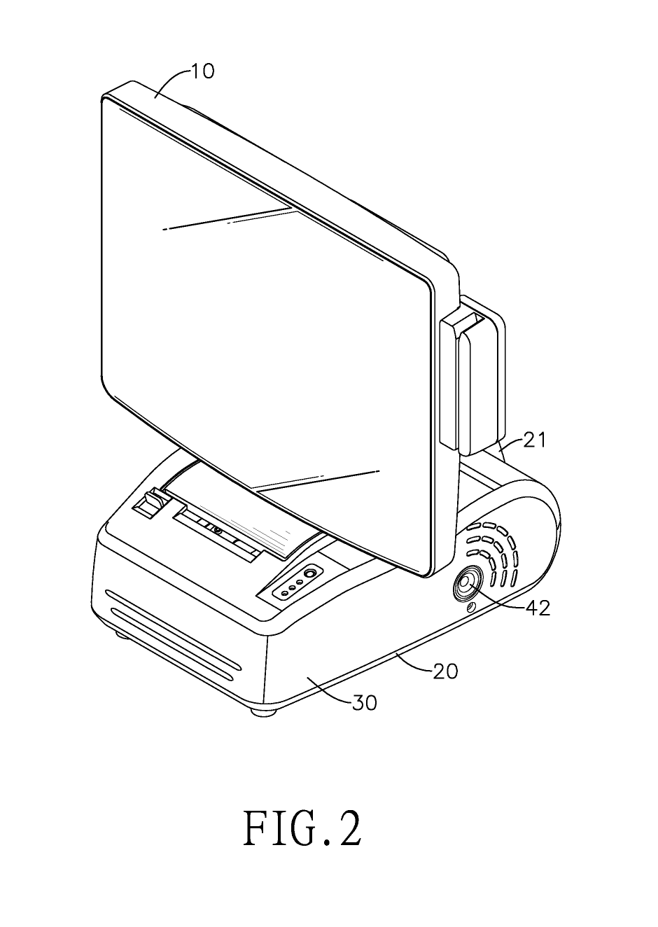

With reference to FIGS. 1 and 2, a POS system with a detachable printer in accordance with the present invention includes a screen 10, a lower case 20, a support arm 21, two resilient latching assemblies 40 and an upper case 30. A printer is accommodated in and enclosed by the lower case 20 and the upper case 30, which as a whole constitute a base for accommodating the printer.

The support arm 21 is connected between the screen 10 and the lower case 20. The two resilient latching assemblies 40 are mounted on the lower case 20. The upper case 30 is joined to the lower case 20 to partially enclose the resilient latching assemblies 40. In the present embodiment, the screen 10 is a touch screen.

The lower case 20 has a left edge portion, a right edge portion and a rear edge portion. The resilient latching assemblies 40 are respectively mounted on the left edge portion and the right edge portion of the lower case 20. The support arm 21 has a top portion and a bottom portion. The top portion of the support arm 21 is securely mounted on the rear edge portion of the lower case 20. The screen 10 is mounted on the top portion of the support arm 21.

The upper case 30 has a bordering portion, a left sidewall and a right sidewall. The bordering portion of the upper case 30 is joined to that of the lower case 20. Each of the left sidewall and the right sidewall has an opening 31 formed through a corresponding one of the left sidewall and the right sidewall. Each resilient latching assembly 40 is mounted through one of the openings 31 for the upper case 30 to be securely mounted on the lower case 20.

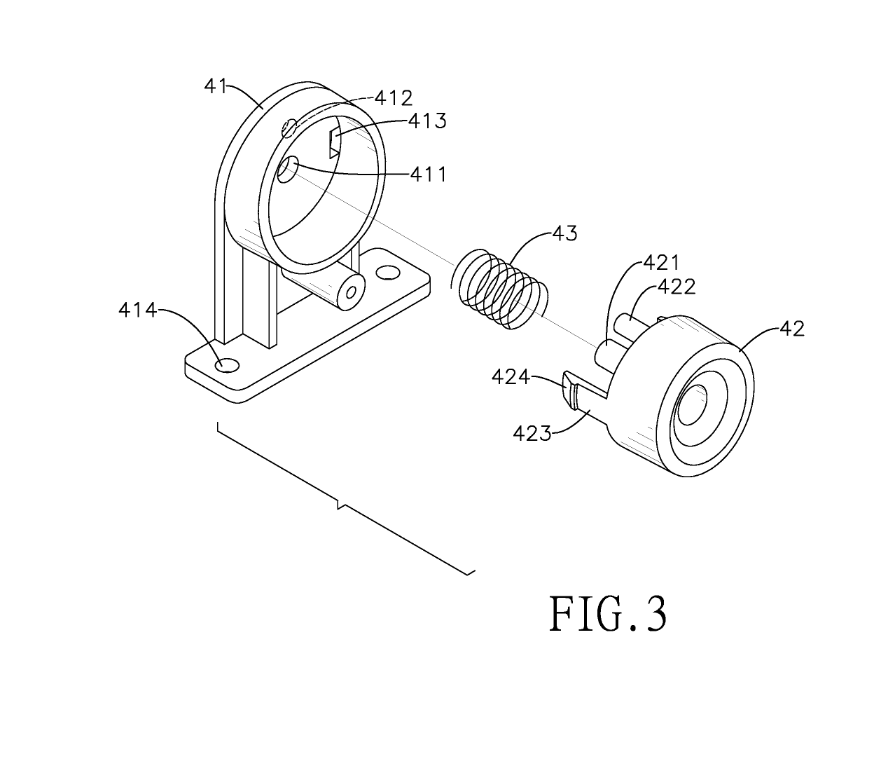

As to how to securely mount the upper case 30 to the lower case 20, with reference to FIGS. 1 and 3, the two resilient latching assemblies 40 are respectively mounted on a left side portion and a right side portion of the lower case 20. Each resilient latching assembly 40 has a seat 41 and a detachable lock. The detachable lock is detachably mounted through the seat 41, is extendable and retractable in a horizontal direction through the two openings 31 of the upper case 30, and is detachably mounted through one of the openings 31 of the upper case 30. In the present embodiment, the seat 41 has a first positioning hole 411, a second positioning hole 412 and two engagement holes 413. The first positioning hole 411, the second positioning hole 412 and the two engagement holes 413 are laterally formed through the seat 41. The second positioning hole 412 is located above the first positioning hole 411. The two engagement holes 413 are located on two opposite side portions beside the first positioning hole 411. The detachable lock has a press button 42 and a resilient element 43. The press button 42 has a first positioning pin 421, a second positioning pin 422 and two engagement pins 423. The first positioning pin 421 is centrally formed on and protrudes inwards from an inner side of the press button 42, corresponds to the first positioning hole 411 of the seat 41, and is mounted through the first positioning hole 411. The second positioning pin 422 is formed on and protrudes inwards from the inner side of the press button 42, is located above the first positioning pin 421, corresponds to the second positioning hole 412, and is mounted through the second positioning hole 412. The engagement pins 423 are formed on and protrude inwards from the inner side of the press button 42, are located on two sides of the first positioning pin 421, correspond to the respective engagement holes 413 of the seat 41, and are mounted into the respective engagement holes 413. Each engagement pin 423 has a barb-like protrusion 424 formed on a free end of the engagement pin 423. After the engagement pins 423 are fully inserted into the respective engagement holes 413, the barb-like protrusions 424 are slid into and securely mounted inside the respective engagement holes 413 to prevent the engagement pins 423 from being separated from the respective engagement holes 413. The resilient element 43 is mounted around the first positioning pin 421. When the press button 42 is pressed, the press button 42 first compresses the resilient element 43 and the first positioning pin 421, the second positioning pin 422 and the engagement pins 423 travel along the horizontal direction, such that the first positioning pin 421 and the second positioning pin 422 respectively penetrate through the first positioning hole 411 and the second positioning hole 412. After the press button 42 is released, the resilient element 43 ejects the press button 42 outwards in the horizontal direction and the barb-like protrusions 424 are securely retained in the respective engagement holes 413. Given the foregoing structure, the detachable lock can be inserted into the seat 41. In the present embodiment, the resilient element is a spring.

The seat 41 further has multiple fastening holes 414 formed through a bottom portion of the seat 41. The lower case 20 has multiple screw holes 23 formed through the left side portion and the right side portion of the lower case 20. The multiple fastening holes 414 of the seat 41 respectively correspond to the multiple screw holes 23 of the lower case 20 for the seats 41 to be securely mounted on the lower case 20 with multiple screws 50.

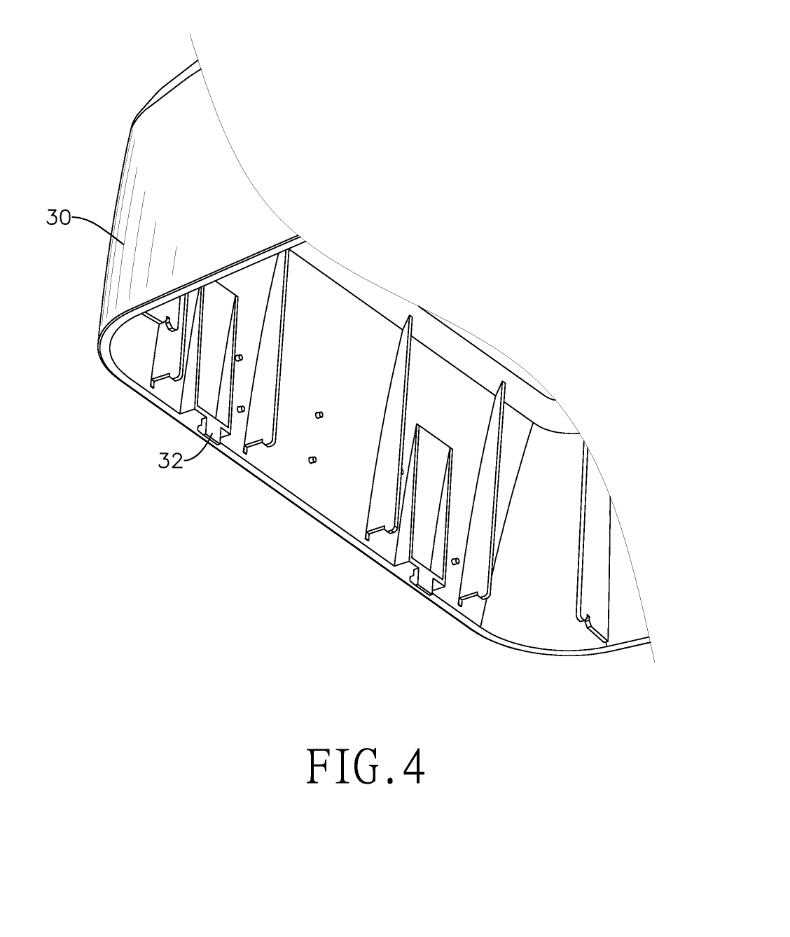

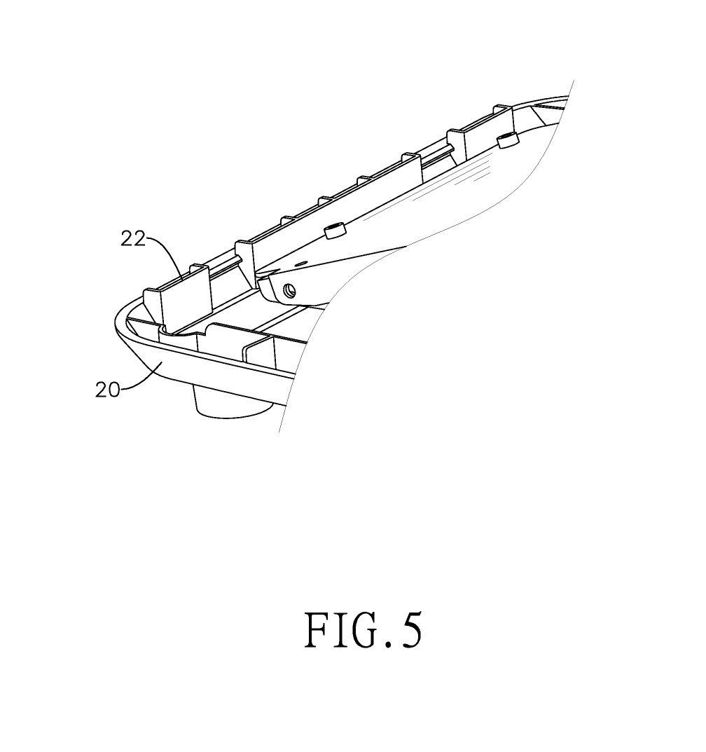

With reference to FIGS. 4 and 5, the lower case 20 further has a front edge portion and at least one first coupling member 22 formed on the front edge portion. The upper case 30 further has a front sidewall and at least one second coupling member 32 formed on the front side wall. The at least one first coupling member 22 of the lower case 20 respectively corresponds to and engage the at least one second coupling member 32. In the present embodiment, there are multiple first coupling members 22 and multiple second coupling members 32, and the multiple first coupling members 22 are formed on the front edge portion of the lower case 20 in pairs and the multiple second coupling members 32 are also formed on the front sidewall of the upper case 30 in pairs.

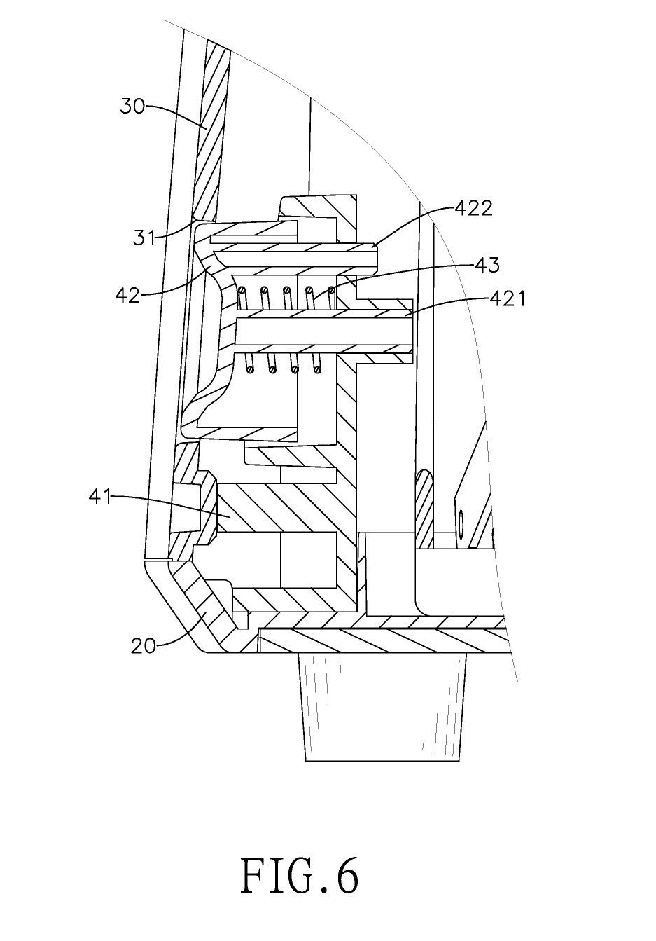

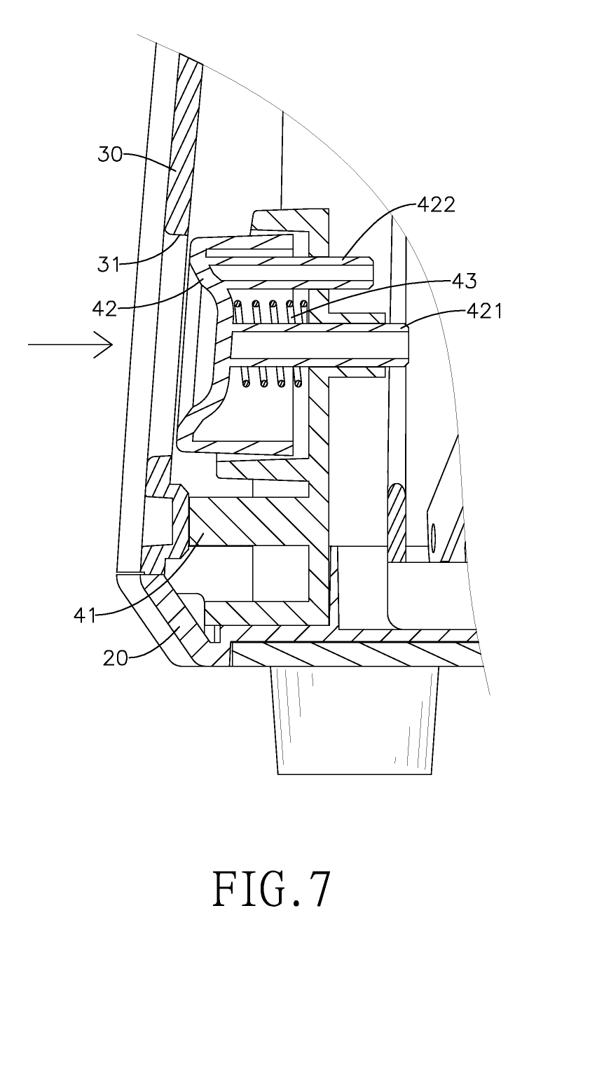

With reference to FIGS. 6 and 7, disassembly of the POS system is described as follows. When users intend to disassemble the upper case 30, both the press buttons 42 of the resilient latching assemblies 40 are pressed to move the press buttons 42 in the horizontal direction to compress the respective resilient elements 43 and the barb-like protrusions 424 are not retained in and escape from the respective engagement holes 413, such that the press buttons 42 can be removed from the openings 31 of the upper case 30. Also because the upper case 30 is unlocked after the removal of the press buttons 42, the upper case 30 can be easily detached from the lower case 20. When users intend to put the upper case 30 back, the at least one second coupling member 32 of the upper case 30 respectively engages the at least one first coupling member 22 of the lower case 20, the press buttons 42 are aligned with the respective openings 31 of the upper case 30 and are securely inserted into the upper case 30 through the respective openings 31. Therefore, the assembly and disassembly of the upper case 30 and the lower case 20 of the POS system become a simple and easy job to do.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A point-of-sale (POS) system with a detachable base accommodating a printer, comprising:
a lower case having a left edge portion and a right edge portion;
two resilient latching assemblies respectively mounted on the left edge portion and the right edge portion of the lower case, each resilient latching assembly having:
a seat; and
a detachable lock detachably mounted through the seat; and
an upper case having a left sidewall and a right sidewall, wherein two openings are respectively formed through the left sidewall and right sidewall of the upper case to correspond to the two resilient latching assemblies, the upper case is joined to the lower case, and the upper case and the lower case are adapted to enclose a printer therein.

2. The POS system as claimed in claim 1, wherein the detachable lock is extendable and retractable in a horizontal direction through the two openings of the upper case and has a press button and a resilient element.

3. The POS system as claimed in claim 2, wherein each seat has an engagement hole formed through the seat, and each press button has an engagement pin corresponding to and engaging the engagement hole of one of the two seats.

4. The POS system as claimed in claim 3, wherein each engagement pin has a barb-like protrusion formed on a free end thereof and engaging the engagement hole of one of the two seats.

5. The POS system as claimed in claim 4, wherein each seat has a first positioning hole formed through the seat and located between the two engagement holes of the seat, each press button has a first positioning pin formed on and protruding inwards from an inner surface of the press button and corresponding to and engaging the first positioning hole of one of the two seats, and each resilient element is mounted around the first positioning pin of one of the two press buttons.

6. The POS system as claimed in claim 5, wherein each seat has a second positioning hole formed through the seat and located above the first positioning hole of the seat, each press button has a second positioning pin formed on the press button and corresponding to and mounted through the second positioning hole of one of the two seats.

7. The POS system as claimed in claim 6, wherein the lower case further has a front edge portion and at least one first coupling member formed on the front edge portion of the lower case, the upper case further has a front sidewall and at least one second coupling member formed on the front sidewall of the upper case, and the at least one first coupling member of the lower case corresponds to the at least one second coupling member of the upper case.

8. The POS system as claimed in claim 7, wherein the lower case further has a support arm connected between the lower case and the upper case, and a screen is securely mounted on a top portion of the support arm.

9. The POS system as claimed in claim 8, wherein the resilient element is a spring and the screen is a touch screen.
